(19) United States
(12) Patent Application Publication
(10) Pub. No.: US 2005/0267939 A1
(43) Pub. Date: Dec. 1, 2005

(54) Transparent security for electronic mail messages

(75) Inventors: Scott Davidson, Stoneham, MA (US); Andrew S. Myers, Wayland, MA (US); Mary E. Raven, Merrimack, NH (US); John C. Wray, Chelmsford, MA (US)

Correspondence Address: CHRISTOPHER & WEISBERG PA, 200 E LAS OLAS BLVD, SUITE 2040, FT LAUDERDALE, FL, 33301, US

(73) Assignee: International Business Machines Corporation, Armonk, NY (US)

(21) Appl. No.: 10/847,116

(22) Filed: May 17, 2004

(51) Int. Cl. B42D 15/00

(52) U.S. Cl. 709/206

(57) ABSTRACT

A method, system and apparatus for the transparent security for electronic mail (e-mail) messages. A method for transparently securing an e-mail message can include producing a secured form of an e-mail message and identifying at least one designated recipient of the e-mail message for whom a secured form of the e-mail message cannot be produced and understood. Consequently, the secured form can be selectively transmitted to designated recipients able to process the secured form, while an unsecured form of the e-mail message can be transmitted to those identified recipients unable to process the secured form without first requiring confirmation from a sender of the e-mail message to transmit the unsecured form instead of the secured form.

### BACKGROUND OF THE INVENTION

1. Statement of the Technical Field

The present invention relates to the electronic mail (e-mail), and more particularly to the secure transmission of e-mail messages.

2. Description of the Related Art

Electronic mail, referred to in the art as e-mail, has proven to be the most widely used computing application globally. Though e-mail has been a commercial staple for several decades, due to the explosive popularity and global connectivity of the Internet, e-mail has become the preferred mode of communications, regardless of the geographic separation of communicating parties. Today, more e-mails are processed in a single hour than phone calls. Clearly, e-mail as a mode of communications has been postured to replace all other modes of communications save for voice telephony.

Strictly speaking, an e-mail is a document which has been universally formatted and which can be carried as a payload to a message in an inter-process communications session between two or more computing devices. E-mail client software can be charged with the composition of the underlying message and its configuration into a universally recognizable format. E-mail client software further can be charged with the interpretation of an e-mail message from its universally format into a presentable format which can be understood by the recipient. Importantly, as e-mail messages can be formatted in a universally recognizable format, e-mail can be exchanged between communicants regardless of the type of e-mail client utilized by the communicants so long as the e-mail clients are configured to process the universally recognizable format.

In initial implementations of e-mail processing systems, e-mail messages were transmitted to communicants nakedly in the universally recognizable format. Given the infancy of computing technology, the limited number of corporate e-mail users and the limited number of individuals skilled in the art of “hacking”, security and confidentiality were of no concern to the typical e-mail user. In the 21st century, however, e-mail has become the preferred mode of communications in the enterprise. Accordingly, in recent times encryption has played a larger role in the transmission of e-mail. In particular, e-mail clients have been configured both to encrypt the contents of an e-mail message and also to sign the e-mail so as to indicate to a recipient the source of the e-mail message.

Presently, several mechanisms exist for the protection of e-mail messages with digital signatures and encryption. Although these mechanisms have proven to be useful tools for information technology professionals, for the typical e-mail user, the use of these mechanisms can be complex and burdensome. As such, it is preferred to shield end users as much as possible from the use of encryption and signing technologies. Yet, encryption and signing mechanisms often require interaction with the end user. In particular, end users often are called upon to resolve difficulties in the signing and/or encryption of an e-mail. Typically, the e-mail client can prompt the end user in these circumstances to decide whether or not to transmit an e-mail to a set of recipients when “the message cannot be encrypted for all recipients.” To prompt the end user, however, can introduce confusion into the encrypting and signing process for those end users who are not computer savvy. In particular, it can be desirable to implement transparent security for e-mail messages without forcing end user involvement.

### SUMMARY OF THE INVENTION

The present invention addresses the deficiencies of the art in respect to transmitting secure e-mail messages and provides a novel and non-obvious method, system and apparatus for transparently securing e-mail messages. A method for transparently securing an e-mail message can include producing a secured form of an e-mail message and identifying at least one designated recipient of the e-mail message for whom a secured form of the e-mail message cannot be produced and understood. Consequently, the secured form can be selectively generated for transmission to designated recipients able to process the secured form, while an unsecured form of the e-mail message can be generated for transmission to identified recipients unable to process the secured form of the e-mail message without first requiring confirmation from a sender of the e-mail message to transmit the unsecured form instead of the secured form.

In a specific embodiment of the present invention, the producing step can include the step of encrypting the e-mail message. Alternatively, the producing step can include the step of signing the e-mail message. In a preferred embodiment, however, the producing step can include both the step of encrypting the e-mail message and also the step of signing the e-mail message. In any case, the method can include the step of presenting a set of delivery options, the delivery options including a “secure” mode, a “secure if possible” mode, and a “do not secure” mode. As such, the transmitting step can be performed without user interaction only if the “if possible” mode has been selected through the presentation.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an e-mail message transmission system which has been configured in a preferred aspect of the present invention;

FIGS. 2A through 2C are screen-shot illustrations of user interface components of the system of FIG. 1; and,

FIG. 3 is a flow chart illustrating a process for transparently securing the transmission of e-mail messages in the system of FIG. 1.

### DETAILED DESCRIPTION OF THE PREFERRED EMBODIMENTS

The present invention is a method, system and apparatus for the transparent securing of e-mail messages. In accordance with the present invention, an e-mail processing system can be configured to enable the securing of an e-mail message without also requiring an end-user to intervene when it is determined that a secure e-mail cannot be generated appropriately for a designated recipient. More specifically, by supporting an “if possible” state in the process of generating a secure e-mail, an e-mail message can be secured and transmitted to one or more target recipients where possible, and otherwise the e-mail message can be transmitted without security to target recipients in a transparent fashion without first prompting the end-user whether or not to transmit the e-mail message without security. Preferably, the security applied to the e-mail message can include encryption, signing, or both.

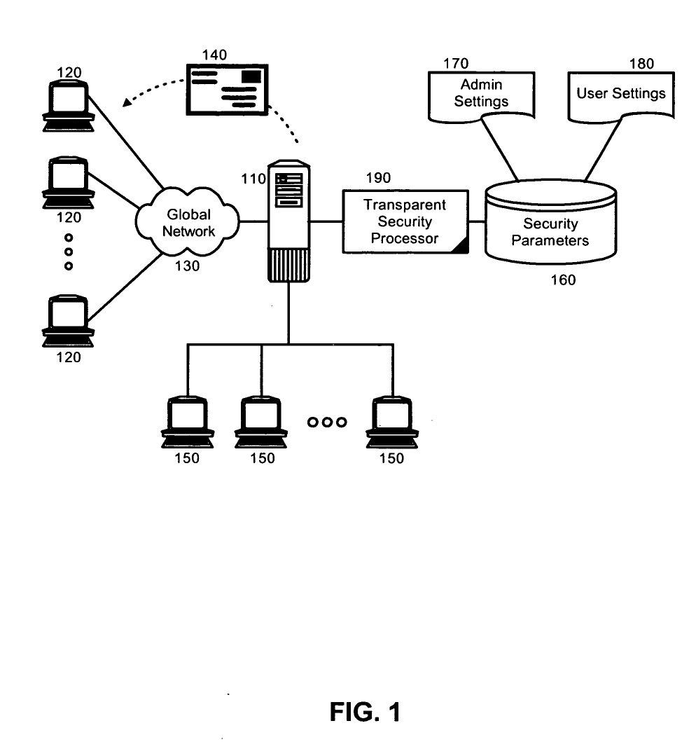

In more particular illustration of the foregoing invention, FIG. 1 is a schematic illustration of an e-mail message transmission system configured for the transparent securing of e-mail messages. The e-mail transmission system of FIG. 1 can include a mail server 110 configured for communicative linkage to one or more e-mail clients 150. The e-mail clients 150, through operation of the mail server 110, can cause the transmission of e-mail messages 140 to designated e-mail recipients 120 over a global computer communications network 130, for example the Internet. Notably, either the e-mail clients 150, or the mail server 110 (or both) further can include logic for supporting the secure transmission of e-mail messages 140, such as through encryption or signing.

In accordance with the present invention, a transparent security processor 190 can be coupled to one or more of the mail clients 150, the mail server 110, or both. The transparent security processor 190 can include logic for processing the transmission of secure e-mail messages based upon security parameters 160. The security parameters 160 can include a specification of whether e-mail messages are to be secured always, never, or only if possible. In the circumstance where the e-mail messages 140 are always to be secured, the end user can be prompted with an error message when one or more of the designated recipients 120 are unable to process a secure form of the e-mail message 140 from the sending end user. Conversely, in the circumstance where the e-mail messages 140 are never to be secured, the e-mail messages 140 can be transmitted to the designated recipients 120 without security.

Notably, the e-mail messages 140 can be secured according to the “if possible” mode specified in the security parameters 160. In the “if possible” mode, selected ones of the e-mail messages 140 intended for corresponding ones of the designated recipients 120 which are able to process secure ones of the e-mail messages 140 are transmitted in secure form. By comparison, selected ones of the e-mail messages 140 intended for corresponding ones of the designated recipients 120 which are not able to process secure ones of the e-mail messages 140 are transmitted in an unsecured form. Importantly, in the latter case, the unsecured form of the selected ones of the e-mail messages 140 can be transmitted without first prompting the end user with an error condition. In this regard, the selective transmission of the e-mail messages 140 in both secured and unsecured form can occur transparently to the end user without requiring end user intervention.

In a preferred aspect of the present invention, the security parameters 160 can include both an administrative policy 170 and user settings 180 which can include both user preferences for all messages originating for an individual user, and delivery options for individual messages. The administrative policy 170 can dictate the flow of allowable and default settings in the user settings 180 and for individual ones of the e-mail messages 140. For instance, the administrative policy 170 can specify whether an end user is able to generate messages in a secure form, whether e-mail messages are always to be secured, or whether e-mail messages can be secured in a best efforts only, “if possible” mode. As permitted by the administrative policy 170, the user settings 180 can specify on a user by user basis, and even on a message by message basis, whether an e-mail message is to be secured, secured only if possible, or never secured. Notably, access to each of the user settings 180 and the administrative policy 170 can be provided through a programmatic user interface provided either through the mail server 110 or through the respective mail clients 150.

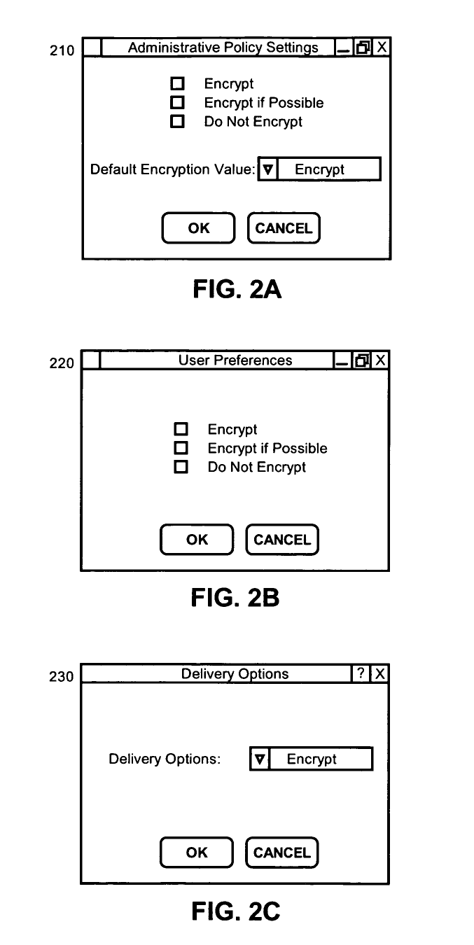

In more particular illustration, FIGS. 2A through 2C are screen-shot illustrations of user interface components of the system of FIG. 1. In FIG. 2A, a screen shot of an administrative policy settings dialog box 210 is shown. The administrative settings which are to be established therein can include an “Encrypt” setting, an “Encrypt If Possible” setting, and a “Do Not Encrypt” setting. In addition, a default encryption value can be established for the user preferences. In this regard, In FIG. 2B, a screen shot of a user settings dialog box 220 is shown. The user settings which are established therein can include an “Encrypt” setting, an “Encrypt If Possible” setting, and a “Do Not Encrypt” setting. The default setting for the user preferences can be derived from the corresponding administrative policy settings of FIG. 2A. Notably, the skilled artisan will recognize that a similar configuration can be applied for digital signature settings and other security and authorization mechanisms.

When an end user composes an e-mail message, the end user can choose the delivery options as shown in the window 230 of FIG. 2C. The window 230 can provide a user interface mechanism through which the end user can select whether the composed e-mail message is to be secured, secured only if possible based upon a target recipient or recipients, or whether the composed e-mail message is not to be secured. The choices present in window 230 can be limited by the choices specified in the user preferences dialog box 220, which in turn can be limited by the administrative policy settings of the administrative policy settings dialog box 210.

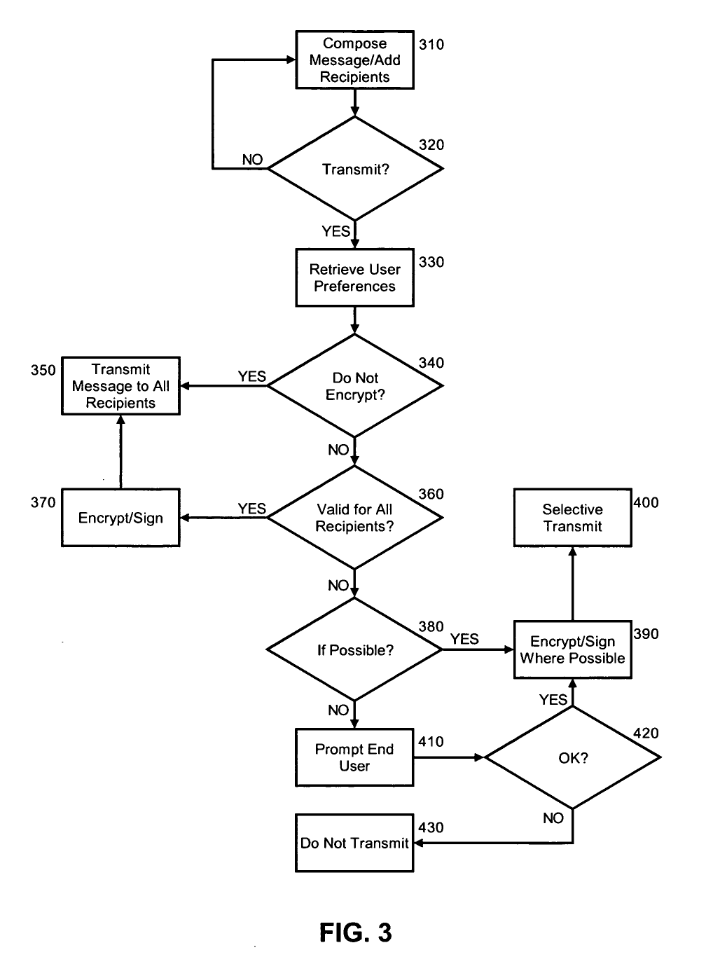

FIG. 3 is a flow chart illustrating a process for transparently securing the transmission of e-mail messages in the system of FIG. 1. Beginning in blocks 310 and 320, an e-mail message can be composed, one or more target recipients for the e-mail message can be specified, and the delivery options can be specified. If, in decision block 330 the delivery options indicate a preference not to secure e-mail messages, for instance by way of encryption or signing (or both), in block 360, the e-mail message can be transmitted to all designated recipients.

If, in decision block 330, the delivery options indicate a preference to secure e-mail messages, in decision block 340 it can be determined whether the secured e-mail message can be produced for all designated recipients of the e-mail message. If so, in block 350 the e-mail message can be secured, for example by way of encryption and digital signing, and in block 360 the secured e-mail message can be transmitted to all designated recipients. By comparison, if in decision block 340 it is determined that the secured form of the e-mail message cannot be produced for all designated recipients, in decision block 370 it can be determined whether the user preferences indicate a preference for “if possible”, best efforts treatment of the secured form of the e-mail message.

If it is determined in decision block 370 that the e-mail message must be secured and delivered to designated recipients of the e-mail message, in block 390 the end user can be prompted to indicate an error condition in as much as the e-mail message cannot be produced for all of the designated recipients. Optionally, in decision block 400 at the behest of the end-user, the secured form of the e-mail message can be created in block 380 and in block 360 a secured form of the e-mail message can be transmitted to the designated recipients as possible, and an unsecured form of the e-mail message can be transmitted to those designated recipients for which a secure form of the e-mail message cannot be produced. Otherwise, in block 410 the message will not be transmitted.

Importantly, if in decision block 370 it is determined that e-mail messages are to be delivered to designated recipients on an “if possible” basis, the secured form of the e-mail message can be created in block 380 and in block 360 a secured form of the e-mail message can be transmitted to the designated recipients as possible, and an unsecured form of the e-mail message can be transmitted to those designated recipients for which a secure form of the e-mail message cannot be produced. Significantly, the latter operation can be performed without first requiring a confirmation on the part of the end user. Rather, the selective transmission of the e-mail message—partly in secured form, partly in unsecured form—can be undertaken transparently to the end user.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A method for transparently securing an e-mail message comprising the steps of:
producing a secured form of an e-mail message;
identifying at least one designated recipient of said e-mail message for whom a secured form of said e-mail message cannot be produced and understood; and,
selectively transmitting said secured form to designated recipients able to process said secured form, while transmitting an unsecured form of said e-mail message to said identified at least one designated recipient without first requiring confirmation from a sender of said e-mail message to transmit said unsecured form of said e-mail message instead of said secured form of said e-mail message.

2. The method of claim 1, wherein said producing step comprises the step of encrypting said e-mail message.

3. The method of claim 1, wherein said producing step comprises the step of signing said e-mail message.

4. The method of claim 1, wherein said producing step comprises the step of signing and encrypting said e-mail message.

5. The method of claim 1, further comprising the steps of:
presenting a set of delivery options, said delivery options comprising a secure mode, a secure if possible mode, and a do not secure mode; and,
performing said transmitting step only if said if possible mode has been selected through said presentation.

6. The method of claim 5, further comprising the step of prompting said sender of said e-mail message for instructions whether to perform said transmitting step if said secure mode has been selected.

7. The method of claim 5, further comprising the step of transmitting only said unsecured form of said e-mail message and not said secured form if said do not secure mode has been selected.

8. A system for transparently securing an e-mail message comprising:
a mail processing system;
a transparent security processor coupled to said mail processing system; and,
a set of security parameters configured for access by said transparent security processor, said parameters comprising a secure mode setting, a secure if possible mode setting, and a do not secure mode setting.

9. The system of claim 8, wherein said set of security parameters comprise an administrative policy interface, a user preferences interface and a delivery options interface, said administrative policy interface limiting which of said parameters can be accessed in said user preferences interface and defining default settings for said user preferences interface.

10. The system of claim 9, wherein said administrative policy is configured to limit available options able to be presented through said user preferences interface.

11. The system of claim 9, wherein said administrative policy is configured to limit available options able to be presented through said delivery options interface.

12. The system of claim 9, wherein said administrative policy configured to establish a default user preference established in said user preferences interface.

13. The system of claim 9, wherein said user preferences interface is configured to specify a default delivery option presented through said delivery options interface.

14. A machine readable storage having stored thereon a computer program for transparently securing an e-mail message, the computer program comprising a routine set of instructions which when executed by a machine cause the machine to perform the steps of:
producing a secured form of an e-mail message;
identifying at least one designated recipient of said e-mail message for whom a secured form of said e-mail message cannot be produced and understood; and,
selectively transmitting said secured form to designated recipients able to process said secured form, while transmitting an unsecured form of said e-mail message to said identified at least one designated recipient without first requiring confirmation from a sender of said e-mail message to transmit said unsecured form of said e-mail message instead of said secured form of said e-mail message.

15. The machine readable storage of claim 14, wherein said producing step comprises the step of encrypting said e-mail message.

16. The machine readable storage of claim 14, wherein said producing step comprises the step of signing said e-mail message.

17. The machine readable storage of claim 14, wherein said producing step comprises the step of signing and encrypting said e-mail message.

18. The machine readable storage of claim 14, further comprising the steps of:
presenting a set of delivery options, said delivery options comprising a secure mode, a secure if possible mode, and a do not secure mode; and,
performing said transmitting step only if said if possible mode has been selected through said presentation.

19. The machine readable storage of claim 18, further comprising the step of prompting said sender of said e-mail message for instructions whether to perform said transmitting step if said secure mode has been selected.

20. The machine readable storage of claim 18, further comprising the step of transmitting only said unsecured form of said e-mail message and not said secured form if said do note secure mode has been selected.
